(19) United States
(12) Patent Application Publication
(10) Pub. No.: US 2016/0098900 A1
(43) Pub. Date: Apr. 7, 2016

(54) PLAYER FOCUSED METHOD OF PARI-MUTUEL WAGERING AND OTHER TYPES OF WAGERING IN REAL TIME

(71) Applicant: Mark BENRUS, North Aurora, IL (US)

(72) Inventor: Mark A. BENRUS, North Aurora, IL (US)

(21) Appl. No.: 14/891,882

(22) PCT Filed: Jun. 11, 2013
(86) PCT No.: PCT/US13/45048

§ 371 Date: Nov. 17, 2015

(51) Int. Cl. G07F 17/32; G07F 17/42; G06Q 50/34

(52) U.S. Cl. CPC G07F 17/3258; G06Q 50/34; G07F 17/3223; G07F 17/42; G07F 17/3209; G07F 17/3204; G07F 17/3269; G07F 17/3288

(57) ABSTRACT

The present invention is directed to a method of wagering on live sporting events, horse and dog races or jai alai games, or similar games or races or similar games or races that allow for pari-mutuel wagering on multiple players or runners in real time.

### CROSS REFERENCE

The present application claims benefit to the international filing of application PCT/US2013/045048 filed on Jun. 11, 2013 by same applicant.

### TECHNICAL FIELD

This invention relates to the gaming industry and, more particularly, to a player focused method of wagering using real time horse or dog races, jai alai games, or similar games or races that allow for pari-mutuel wagering on multiple players or runners or the like. The invention is also directed to a wagering system of the type through which the inventive wagering method can be practiced.

### BACKGROUND ART

The success of the slot machine has had a devastating effect on the live horse and dog racing industry. Slot machines appeal to a much larger audience of bettors because they appeal to all levels of gambling expertise. Beginning bettors at slot machines not only do not need to know the mechanics of a particular game to be successful at wagering, but also do not need to study probabilities to make a calculated wager. To be successful at gambling with slot machines, individuals need only operate a switch through a button or lever, with the results being entirely random and beyond the operator's control. Success at a track, on the other hand, generally requires extensive study of both race forms and race results as well as an intimate understanding of handicapping. The random selection in slot machine gambling obviates the need for understanding handicapping or probabilities. Therefore, in slot machine gambling there is no concept of making a “mistake.” Due to the complete randomness of the results in slot machines, the bettor simply makes a wager and hopes for the best. In addition to the complexity in horse and dog race gambling, there is also the public perception that many track races are “fixed.” Still further, many race tracks have undesirable, antiquated facilities, causing people interested in live races to frequent off-track facilities instead.

To reverse the downward trend at race tracks, it would be desirable to enable gamblers to place wagers on live horse and dog races and jai alai games, or similar games or races, with the ease and convenience of slot machine gambling. It would further be desirable for the gambler to have more involvement in the game to keep the gambler stimulated during the course of play.

### DISCLOSURE OF INVENTION

The present invention is directed to a method of wagering on live events including horse and dog races or jai alai games, sporting events, auto racing events, or similar games or races, including the steps of an input wager placed by a user, where at least part of the wagering base is at least two real time live events of a specific type, such as baseball games, that in real time have yet to start and possess start times that fall within a predetermined period of time from the time in which the input wager was placed by the user; the at least two real time events are randomly selected from any real time events that fall within the predetermined period of time by assigning a random number to each event using a random number generator; a type of wager for the randomly selected real time event is then randomly selected using a random number generator; using the randomly selected type of wager, the number of runners, teams or specific players are then determined in accordance with the number of runners, teams or specific players required for the type of wager; a runner, team or specific player for each randomly selected real time event is randomly selected using the random number generator; the at least two real time events, the randomly selected type of wagers and the randomly selected teams or specific player (the “randomly selected wagering base”) are correlated to the input wager and become the user's “pending wager;” once said real time event begins, the user's pending wager becomes the user's “in progress wager;” the outcome of the randomly selected real time event is identified; the outcome of the randomly selected real time event is correlated to the user's in progress wager, and a return for the in progress wager is identified.

In one embodiment, the present invention is directed to a method of wagering on horse and dog races or jai alai games that allow for pari-mutuel wagering on multiple players or runners, including the steps of an input wager placed by a user, where at least part of the wagering base is at least two real time horse or dog races or jai alai games or similar games or races, specifically horse or dog races or jai alai games that in real time have yet to start and possess start times that fall within a predetermined period of time from the time in which the input wager was placed by the user; the at least two real time horse or dog races or jai alai games are randomly selected from any real time horse or dog races or jai alai games, or similar games or races that fall within the predetermined period of time by assigning a random number to each real time horse or dog race or jai alai game using a random number generator; a type of wager for the randomly selected real time horse or dog race or jai alai game is then randomly selected using a random number generator; using the randomly selected type of wager, the number of runners are then determined in accordance with the number of runners required for the type of wager; a runner or runners for each randomly selected real time horse or dog races or jai alai games are randomly selected using the random number generator; the at least two real time horse or dog races or jai alai games, the randomly selected type of wagers and the randomly selected runners (the “randomly selected wagering base”) are correlated to the input wager and become the user's “pending wager;” once said real time horse or dog races or jai alai games begins, the user's pending wager becomes the user's “in progress wager;” the outcome of the randomly selected real time horse or dog races or jai alai games is identified; the outcome of the randomly selected real time horse or dog races or jai alai games is correlated to the user's in progress wager, and a return for the in progress wager is identified.

Through the above method, pari-mutuel wagering can be carried out with significantly increased user involvement leading to greater customer enjoyment. As shown in FIG. 1, in one embodiment of the invention, the above method can be carried out in a “slot machine” format. The display may have multiple slot lines similar to actual slot machine reels where each slot line or “spinning reel” corresponds to a possible wager to be selected by the user. The user will have the option of selecting from the spinning reels to select the possible wager to become the user's “pending wager.” In a preferred embodiment, there is at least one option or “box” per spinning reel that will periodically stop spinning to reveal information about the wager element such as the race, runner or wager type of the possible wager. The user would then select a spinning reel line to become the user's pending wager and the remaining wager elements pertaining to that spinning reel line would be revealed to the user. When the player had completed selecting the total number of wager selections, the wager selections would be summarized for the user and the user could begin the process again. In another embodiment of the present invention, each spinning reel can reveal more than one “box” or elements of the possible wager but as the number of “boxes” or elements are revealed, the numbers of credits wagered by the user also increases. The more information about the possible wager that is revealed for the user, therefore, the larger the input wager is required or number of credits wagered. In a preferred embodiment, the display has touch screen technology. In order for the user to have more boxes or elements of the wager revealed, the user would touch one of the boxes of a desired spinning reel and the box would begin to spin and then reveal the element of the wager to which it corresponds.

As shown in FIG. 2, in another embodiment of the invention, the user may select from a plurality of floating characters, such as floating balloons shown in the Figure, wherein at least one of the characters may reveal an element of the wager. Once the user has selected at least one character, the remaining wager elements pertaining to that character selection would be revealed to the user. The player may continue to place wagers until the number of wagers equals the amount the players desiring to place wagers with each launch of the floating balloons. After such point, the user may begin the wagering method again.

In another embodiment of the invention, the user may select from a set of characters that travel from one end of a display screen to the other, such as a character climbing a ladder in FIG. 4. In one embodiment, there will be a plurality of ladders side by side, wherein each ladder would have a different character climbing that ladder. As the character moves up the ladder, elements of the wager are revealed to the user. The more information revealed for the user, however, the larger the input wager is required or number of credits wagered would be increased. The user may be able to move the character to the top of the ladder thereby revealing elements of the wager but the number of credits would automatically increase. The user is able to select which wager to be placed by selecting a wager “ladder.”

In another embodiment of the invention, the user may select from a set of characters that travel from one end of a display screen to the other, such as illustrated in FIG. 5. Each character would move towards the opposite end of the display from its starting position at various speeds. When each character reached a predetermined position on the display, the character may reveal a wager element, such as the track, wager type or runner. As the character continues to move, the user would select a wagering line of one of the characters and then all of the elements of the user's wager are revealed. Once a selection is made, all of the characters return to their original position to restart the process.

In another embodiment of the present invention, a spinning pie may be displayed with a plurality of triangular slices such as used in the Wheel of Fortune™ game wherein each triangular slice corresponds to a possible wager for the user. In a preferred embodiment, at least one triangular slice would reveal one element of its corresponding possible wager such as the race, runner or wager type. Once the user has selected at least one triangular slice, the remaining wager elements pertaining to that selection would be revealed to the user. The user may have the option of having more elements of the wager revealed, but by doing so the amount of the wager would increase for the user.

Once a pending wager is correlated to the selected real time horse or dog race or jai alai game, the pending wager may be placed into the pari-mutuel pool that is established for that real time horse or dog race or jai alai game, thereby providing for real time pari-mutuel wagering.

Likewise, the return for an in progress wager may be paid from the same pool of returns as the pari-mutuel pool that is established for that real time horse or dog race or jai alai game or similar game or race.

The method may further include the steps of providing multiple locations from which input wagers are received and pending wagers are correlated to selected real time horse or dog race or jai alai games, or similar games or races. With this arrangement, it is possible to network the wagering to increase the handle.

The method may further include the steps of providing multiple input wagers to be processed simultaneously from one single location. With this arrangement, a user may make multiple input wagers simultaneously and have multiple pending wagers correlated to various selected real time horse or dog race or jai alai games, or similar games or races to increase the user's chances of winning

In one embodiment, the input wager may be processed within a terminal whereby a discrete object may be inserted into the terminal by the user. This object may be in the form of a card, bill, coin, ticket, voucher and the like. Alternatively, the input wager may be placed through the use of a prepaid account or credit card whereby the amount of the input wager will be deducted from the balance of such account.

In another embodiment, the input wagering terminal has a repositionable element that is accessible to a user. The discrete object is processed by repositioning the repositionable element after the discrete object is inserted. The repositionable element may be a lever that is pivotable. Alternatively, the input wagering terminal may have push buttons whereby the discrete object may be processed by the depression of the push button by the operator after the discrete object is inserted. The repositioning of the repositionable element or depression of the push button will operate an internal switch that thereby causes the search and selection of the real time horse or dog races or jai alai games, or similar games or races.

To give the location around the input wagering terminal a more realistic feel, an audio and/or visual signal can be produced to one of a) simulate an equestrian event, b) simulate a live race environment, c) assist placement of input wagers, d) identify the beginning of a wagering period, e) identify the end of a wagering period, f) simulate a live game environment, g) audibly or visually broadcast at least part of the at least one real time horse or dog race or jai alai game and h) simulate standard slot machine sounds and visual signals such as flashing lights.

The method may further include the steps of printing a cash voucher which identifies the results of a winning input wager and has a cash value equivalent to the final return on the winning input wager. The method may further include the steps of printing a ticket indicating each of the user's pending or in progress wagers including the randomly selected real time horse or dog races or jai alai games, or similar games or races, the randomly selected type of wager and the randomly selected runner or runners. This ticket may be printed for real time horse or dog races or jai alai games, or similar games or races that have yet to begin or that are already in progress. Such a ticket may allow the user to leave the input wagering terminal once the user's input wager is processed and becomes the user's pending or in progress wager.

In one embodiment, the present invention is directed to a method of wagering on live sporting events, such as baseball, football, basketball, hockey and soccer games, golf and auto racing events. The method of the present invention includes the steps of an input wager placed by a user, where at least part of the wagering base is at least one real time sporting event, such as baseball, basketball, football or soccer games, specifically sporting events that in real time has yet to start and possess start times that fall within a predetermined period of time from the time in which the input wager was placed by the user; the at least one real time sporting event is randomly selected from any real time events that fall within the predetermined period of time by assigning a random number to each real time sporting event using a random number generator; a type of wager for the randomly selected real time sporting event is then randomly selected using a random number generator; using the randomly selected type of wager, the number of teams or specific players are then determined in accordance with the number of teams or specific players required for the type of wager; a team or specific player for each randomly selected real time event is randomly selected using the random number generator; the at least one real time event, the randomly selected type of wagers and the randomly selected teams or specific player (the “randomly selected wagering base”) are correlated to the input wager and become the user's “pending wager;” once said real time event begins, the user's pending wager becomes the user's “in progress wager;” the outcome of the randomly selected real time event is identified; the outcome of the randomly selected real time event is correlated to the user's in progress wager, and a return for the in progress wager is identified.

### BRIEF DESCRIPTION OF DRAWINGS

FIG. 3 is an illustration of a system for pari-mutuel wagering in real time according to the present invention; and

FIG. 1 is a front view of an input wagering terminal that is part of the wagering system.

FIG. 2 is an illustration of an embodiment of the present invention.

FIG. 4 is an illustration of an embodiment of the present invention.

FIG. 5 is an illustration of an embodiment of the present invention.

### MODES FOR CARRYING OUT THE INVENTION

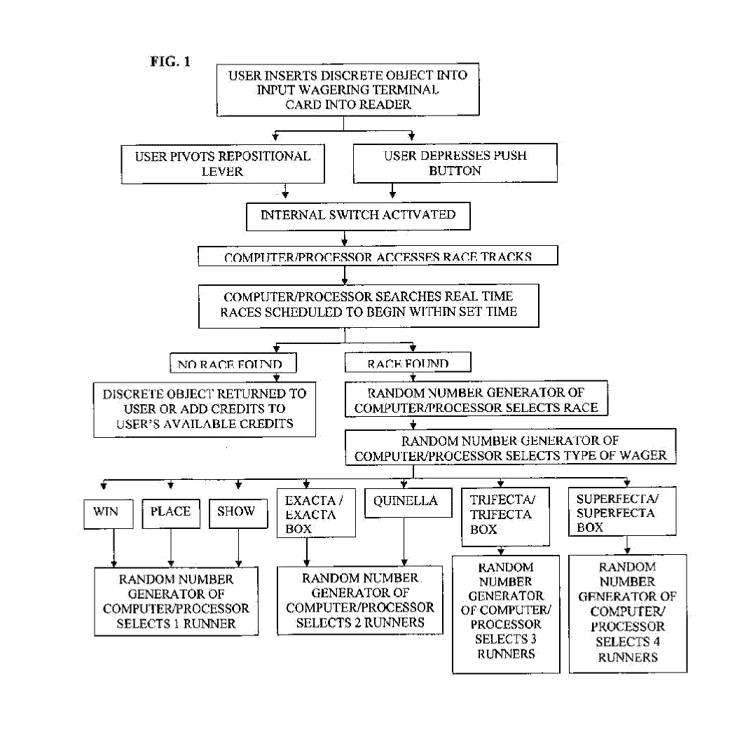

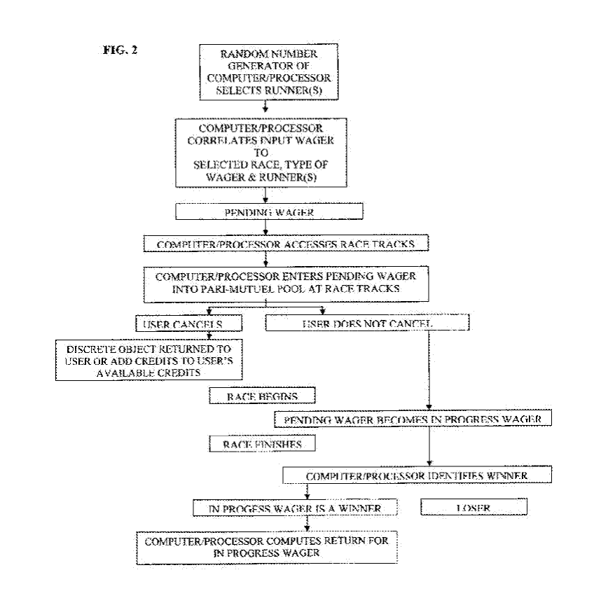

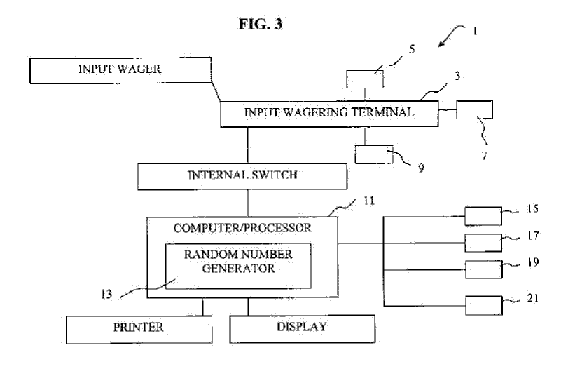

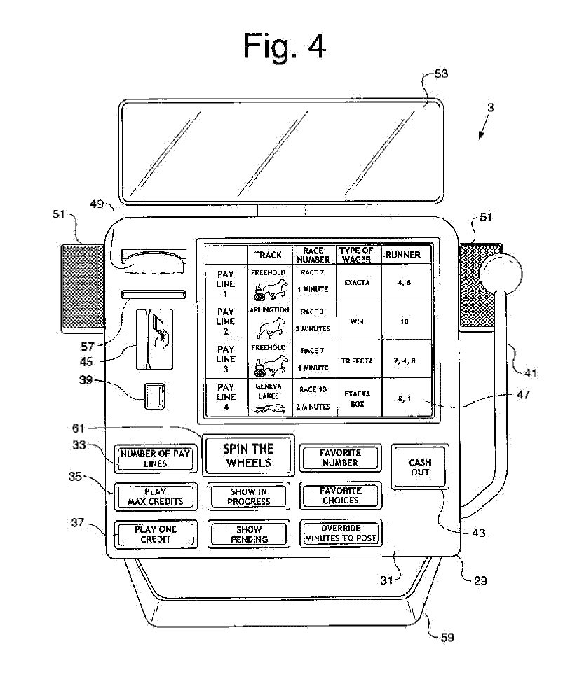

A system of pari-mutuel wagering in real time, according to the present invention, is shown at 1 in FIG. 3. The system consists of at least one input wagering terminal 3, through which a bettor makes a wager. A multitude of terminals, 5, 7, 9 can be linked at the same location, intrastate, interstate and/or internationally.

The invention contemplates that pari-mutuel betting can be carried out in a “slot machine” format.

According to the invention, the system 1 utilizes a processor or computer 11 with a random number generator 13, which has a wagering base made up at least in part by at least one real time live race or a jai alai game or similar game or race. The race may be a horse or dog race or jai alai game, automobile race, or similar game or race or similar game or race that has yet to be run and that allows for pari-mutuel wagering on multiple players or runners or the like.

To make a bet, the user places a discrete object, not shown, which may be in the form of a card, bill, coin, ticket, voucher and the like, into an opening, not shown, in the input wagering terminal 3. Alternatively, the user may use a prepaid account or credit card, not shown, whereby the amount of the input wager will be deducted from the balance of such account. The credit card or prepaid account card may be inserted into a card reader 45. The value of the discrete object or deduction from the prepaid account will be converted into a corresponding value of available credits from which the user can use at the input wagering terminal to place input wagers. Alternatively, the user may use a cash voucher or winning ticket, not shown, and insert such cash voucher or winning ticket into a voucher reader 57 which would be converted to available credits from which the user can place input wagers at the input wagering terminal.

The computer 11 then searches the real time live races or a jai alai games, or similar games or races that are scheduled to begin within a predetermined period of time from the time the user places a discrete object in the input wagering terminal. Advantageously, the computer 11 may be connected via the Internet or via a network to the various race tracks, 15, 17, 19, 21, to determine which races and jai alai games, or similar games or races are about to begin within that predetermined period of time. The random number generator 13 is programmed to assign a random number to each real time live race or a jai alai game that is scheduled to begin within that predetermined period of time. The computer 11 then randomly selects at least two real time live races or games. The computer 11 then randomly selects the types of wager for the real time live races or games by assigning random numbers to the type of wagers available, which may include but are not limited to Win, Place, Show, Exacta, Quinella, Trifecta, Superfecta, Exacta Box, Trifecta Box and Superfecta Box.

The computer 11 then determines the number of runners required for each randomly selected type of wager. A Win, Place, or Show type of wager requires a selection of a single runner because the computer 11 is randomly selecting whether a selected runner will be the winner of such race, place in the top two runners of such race, or make a showing in the top three runners of such race, respectively. If a Win, Place or Show type of wager is randomly selected by the computer 11, a single runner will be randomly selected by the computer processor 11. An Exacta, Quinella or Exacta Box type of wager requires a selection of two runners because the computer is selecting the top two finishers of the race. If the type of wager randomly selected by the computer processor 11 is an Exacta, Quinella, or Exacta Box, two runners will be randomly selected by the computer 11. A Trifecta or Trifecta Box type of wager requires a selection of three runners because the computer is selecting the top three finishers of the race. If the type of wager randomly selected by the computer processor 11 is a Trifecta or Trifecta Box, three runners will be randomly selected by the computer 11. A Superfecta or Superfecta Box type of wager requires a selection of four runners because the computer is selecting the top four finishers of the race. If the type of wager randomly selected by the computer processor 11 is a Superfecta or Superfecta Box, four runners will be randomly selected by the computer 11. Therefore, the types of wagers randomly selected by the computer 11 will also determine the number of runners required for such a type of wager. The computer 11 then randomly selects the runner(s) for the randomly selected real time live races or games and randomly selected type of wagers.

The computer then displays various elements of randomly selected races or games, the randomly selected types of wagers and randomly selected runners on the display 47. The user then makes a selection of at least one element of the wager (e.g., the race, runner or wager type) wherein the remaining elements are not revealed to the user until such selection is made.

Alternatively, the user may have elected to have additional elements of the wager revealed to user and then subsequently make a selection from the possible wagers.

The computer 11 then correlates the selected real time live race or game, the selected type of wager, and the selected runner(s) to the user's input wager to thereby create what may be called the user's “pending wager.” The computer 11 thereafter enters the pending wager into the pari-mutuel pool that is established for the randomly selected real time horse or dog race or jai alai game or similar game or race. The pari-mutuel pools are established at the various race tracks, 15, 17, 19, and 21 from which the real time live races were randomly selected. Advantageously, the computer 11 may be connected via the Internet or via a network to the various race tracks, 15, 17, 19, and 21 to enter the pending wagers into such established pari-mutuel pools.

Once the selected race of the user's pending wager begins in real time at the race track, the user's pending wager is transformed into what may be called the user's “in progress wager.” Advantageously, the computer 11 will deem a user's pending wager an in progress wager when the selected race or game of the user's pending wager is within a set period of time from the start time of such race. Once the real time live race is finished, the computer 11 determines whether the selected runner is a “winner” according to the outcome of such real time live race, terminating the in progress wager.

The type of input wager may be any type of wager a user would be able to choose at a live race track, including but not limited to: Win, Place, Show, Exacta, Quinella, Trifecta, Superfecta, Exacta Box, Trifecta Box and Superfecta Box. When the real time live race is finished, the computer 11 determines whether the selected runner is a “winner;” and if the selected runner is a “winner”, the computer then determines what the payoff is for the in progress wager. Since the in progress wager is entered into the pari-mutuel pool that is established for that real time horse or dog race or jai alai game or similar game or race, the payoff for each in progress wager must be determined in proportion to the amount of the input wager. In this embodiment, the payoff for a “winning” wager would be equivalent to the payoff at the pari-mutuel pool but scaled back in proportion to the value of the input wager.

In another embodiment of the invention, the user would be allowed to override the predetermined period of time to allow for a greater predetermined period of time in which real time live races or games can be selected. In the event that there is no real time live race or game from which to select within that predetermined period of time from the time the user places an input wager, the input wagering terminal 3 would return the discrete object to the user or add the amount of the input wager to an internally maintained record of the user's available credits. Advantageously, the input wagering terminal 3 would produce the same audio and visual signals as if the user was a “winner” to add to the excitement of the wagering experience.

In another embodiment of the invention, the user would be allowed to override the predetermined period of time to allow for a shorter predetermined period of time in which real time live races or games can be selected.

In yet another embodiment, the user can be permitted to select at least one number that the computer 11 would use when randomly selecting the runner(s) such that the at least one number selected by the user must appear in at least one of the runner or other participant numbers selected. If the user selected the number 6 in a horse race, for example, then at least one of the horses randomly selected by the computer would have the running number 6. Such a selection by the user would allow the user to play his or her “favorite” number or numbers. In another embodiment, the user can be permitted to select a “favorite” color that the computer 11 would use when randomly selecting the runner(s) such that the selected “favorite” color would correspond to the saddle color for a runner.

In an alternate embodiment, the user can choose whether the runner that is deemed to be a favorite in the real time live race at the time the computer 11 makes the random selection would be included or excluded from the runner(s) that are randomly selected by the computer 11. Such an embodiment, the user can choose to include or excludes the selection of a favorite from the random selection of the runner(s). Such a choice by the user would be made prior to the random selection of the real time live race or game by the computer 11.

In one embodiment of the invention, the input wagering terminal 3 may be any personal computer or computing device that is linked to the computer 11 and to the random number generator 13 via the Internet. The user thereby can use his or her own personal computer to link to a host computer or server via a network of some type such as the Internet and is allowed to place input wagers from the comfort of his or her home. The computer 11 may be linked to the various race tracks, 15, 17, 19, and 21 via the Internet or via a network to determine which races and jai alai games, or similar games or races are about to begin with a predetermined period of time. The user may use a credit card or prepaid account card to place an input wager, whereby the amount of the input wager will be deducted from the balance of such account. The computer 11 may process the input wager and then take the identical steps as described above to create the user's pending and in progress wagers. The user may also be able to use any hand-held wireless devices such as personal digital assistants (PDA) and cellular phones and any other hand held wireless devices that allow Internet access, to link to the computer 11 via a network of some type such as the Internet to place input wagers. Those of skill in the art will understand that the present invention can be deployed on most any device now available or hereafter developed that allows users to access the Internet.

In one embodiment of the invention, the input wagering terminal 3, as shown in FIG. 4, includes a housing 29 which simulates the appearance of a conventional slot machine. The housing has a front display wall 31 with push or slide button operators. The push or slide button operators 33, 35, 37, may allow the user to select how many credits or the amount of money the user would like to place for each input wager.

The housing has a slot or opening for a coin 39 or other token that is processed to accept the user's input wager. After inputting the coin or other token and the computer 11 has converted the coin or discrete object into a corresponding value of available credits, a repositionable lever 41, in this case a pivotable operating arm as used on slot machines, is pivoted to operate an internal switch, not shown, which thereby causes the random number generator 13 of the computer 11 to search the real time live races or jai alai games or similar games or races that are scheduled to begin within a predetermined period of time. Alternatively, the repositional lever may be replaced with a push button allowing the operator to depress the button 61 to cause the random number generator of the computer 11 to search the real time live races or jai alai games, or similar games or races that are scheduled to begin within a predetermined period of time. As an alternative to a coin actuator, a reader or scanner 45 could be used to identify information on a card to initiate the acceptance of the user's input wager. Such a reader or scanner 45 may be used to identify information on a credit card or card issued by the facility that may function similarly to a debit card issued by a financial institution and to which a user can add money. Alternatively, a voucher reader 57 may be used to identify information on a cash voucher that has a cash value which can be converted to available credits from which a user may place input wagers at the input wagering terminal.

In one embodiment, the housing 29 may have a display 47 that identifies to the user the pending wagers, including but not limited to the following information: the race track or the game location, the specific race or game selected, the type of wager selected, and the runner(s) randomly selected by the computer 11. Advantageously, the user may be given the option to cancel one of the pending wagers prior to the start of the live race or game. In the event a user cancels such a pending wager prior to the start of the live race or game, the input wagering terminal 3 would return the coins or the discrete object to the user or add the amount of the input wager to the available credits to the user.

In one embodiment, a user may be able to place multiple input wagers simultaneously at a single input wagering terminal. Each pending wager then may be shown on the display 47 of the input wagering terminal 3 as a separate “pay line.” The user may also select the number of input wagers to be placed by depressing a button 33 on the front display wall 31 of the input wagering terminal.

In one embodiment, a user may be able to place a single input wager on each of a series of real time live races or games. Advantageously, the user may be able to leave the input wagering terminal 3 once the user's input wager is entered and processed by having the input wagering terminal 3 issue a ticket indicating each of the user's pending or in progress wagers, including: the selected real time horse or dog races or jai alai games or similar games or races, the selected types of wagers, and the selected runners or players.

In one embodiment, the housing may also have a printer 49 that can print a cash voucher which identifies the results of a winning input wager and has a cash value equivalent to the final return on the winning input wager. The printer 49 may also print a ticket (not shown) indicating each of the user's pending or in progress wagers including the randomly selected real time horse or dog races or jai alai games or similar games or races, the randomly selected type of wager, and the randomly selected runner or runners. The ticket may be printed for real time horse or dog races or jai alai games, or similar games or races that have yet to begin or that are already in progress. Such a ticket permits the user to leave the input wagering terminal. Once the outcome of the user's in progress wagers are determined, if one or more of the user's in progress wager are “winners,” the user may use the printed ticket to redeem the user's return or payoff on the in progress wagers from the facility. The printer 49 may also print a voucher or ticket indicating the user's previously-made wagers.

To add another dimension to the system, an audio signal generator 51 and/or a visual image generator 53 can be used to produce effects that can: simulate an equestrian event, a live race or game environment, or a standard slot machine environment; that can assist with the placement of input wagers; that can identify the beginning and the end of a wagering period; and that can in other ways add to the excitement or authenticity of the gaming experience. The randomly selected, real time live race may be broadcast in real time audibly and/or visually through the system, with the actual race shown on the display 47. Advantageously, the user may able to select the race that has been randomly selected by the computer 11 to be received in real time over an Internet connection or other form of direct feed. Alternatively, the display 47 may be connected to the Internet or direct feed such that the real time live race of the user's pending or in progress wager may be broadcast from the display 47. Advantageously, the user may be able to depress a button located on the front display wall 31 that would be connected to a switch, not shown, that would allow the user to select between a live broadcast of the real time live races or games of the user's pending or in progress wagers.

In one embodiment of the invention, the user is able to “cash out” all of the user's available credits by depressing a button 43 located on the front display wall 31. When the button 43 is depressed, the user is given the option of having the input wagering terminal 3: (1) Return the user's available credits in the form of a discrete object or objects, such as one or more coins dropped into a coin receptacle 59; (2) Print a cash voucher which has a cash value equal to the value of the user's available credits from the printer 49; (3) Print a voucher or ticket indicating the user's pending or in progress wagers from the printer 49; (4) Cancel all of the user's pending wagers; and (5) any reasonable combination of the actions (1)-(4).

In one embodiment of the invention, a multitude of terminals are linked together either at one location, or within a single state, or throughout a single country, or even internationally. By networking the terminals together, it is then possible to permit additional wagers to be made between such terminals such as “Bonus Spins” whereby users would be eligible for additional payoffs based upon the input wagers placed at the linked terminals. The terminals may be networked together within the same location, where additional wagers may be made between the networked terminals as in conventional slot machine gambling where users are given the chance to gamble on bonus spins that are termed, “Wheel of Fortune.” Such additional wagers are not entered into the pari-mutuel pools established at the various race tracks 15, 17, 19 and 21 but rather are pools that are set up at each location or networked locations.

In an alternate embodiment of the invention, a multitude of terminals are linked together at one location. By networking the terminals together, it is then possible to permit additional wagers to be made between such terminals so that users may place side wagers between each other. Such additional wagers are not entered into the pari-mutuel pools established at the various race tracks 15, 17, 19 and 21 but rather are pools that are set up at each location or networked locations.

In one embodiment, the computer 11 may be connected via the Internet or via a network to the various race tracks, 15, 17, 19, and 21. The computer 11 may be linked to the various race tracks 15, 17, 19, and 21, through a communication system. The communication system may include a central processing unit that can access and configure the information regarding the real time live races or games at the various race tracks 15, 17, 19, and 21. It may also include a transceiver that can communicate with the input wagering terminal 3 and the central processing unit.

In one embodiment of the invention, the computer 11 may be connected via the Internet or via a network to the other computers 11 in the facility in which the input wagering terminal 3 is located to allow users to communicate with each other. The computer 11 may be linked to a network and programmed to create an identifier and a database for the user and the user's history of wagering. The computer may be further programmed to create an account for a user allowing the user to access the user's wagering history. The identifier would allow the user to log into the network to access the user's wagering history. The network and thereby database may also be accessed by the computer(s) 11 to give the user(s) the statistics of all the results of the wagers within a predetermined time or a specific race within the facility in which the input wagering terminal 3 is located or the entire network.

In yet another embodiment of the invention, the display 47 of the input wagering terminal 3 may have a touch screen keyboard allowing the user to input information into the computer 11 to be transmitted through the network. The touch screen keyboard allows the user to communicate with professional handicappers, other users, or to record information within the user's account. In another embodiment, the display 47 may have a microphone to allow users to communicate with each other.

Although the present invention provides for the random selection of all elements of the wagering base, alternative embodiments of the invention may allow for the selection of at least one element of the wagering base (i.e., the real time event, the type of wager, the runner(s), etc.) to be influenced by the user, handicapper or algorithm. Further, alternative embodiments may allow for the selection of at least one element of the wagering base (i.e, the real time event, the type of wager, the runner(s), etc.) to be influenced by the other factors such as the location of the user or any other factor.

In one embodiment, the user can optionally override the random selection of the real time live race or game by the computer 11 and select the real time live race or game that is scheduled to run in a race track nearest to the physical location of the input wagering terminal 3. In one embodiment of the invention, during the selection of the real time live race or game, the computer 11 may be programmed to place a heavier weight on the selection of the real time live race or game nearest to the physical location of the input wagering terminal 3.

In one embodiment, the user can override the random selection of the type of wager placed by the computer 11 and select to exclude a specific type of wager that may be placed on the real time live race or game, such as Win, Place or Show. Alternatively, during the random selection of the type of wager, the computer 11 may be programmed to place a heavier weight on the selection of the type of wagers of a single runner, such as Win, Place or Show. The type of wagers Win, Place and Show have a greater likelihood of being a “winning” wager given that the user is only wagering on the outcome of a single runner as opposed to multiple runners.

Therefore, by placing a greater weight on the Win, Place and Show types of wagers, the user has a greater likelihood of making a “winning” wager.

In one embodiment of the invention, the user may be able to override the number of runners randomly selected by the computer 11 in a boxed set. For example, for an Exacta Box type of wager, the computer 11 randomly selects two runners because the computer 11 is selecting the top two finishers of the race. The user may override the selection of two runners for an Exacta Box type of wager by increasing the number of runners selected for an Exacta Box type of wager. The user may select as many runners as desired to finish as the top two finishers of the race. As another example, for a Trifecta Box type of wager, the computer 11 randomly selects three runners because the computer 11 is selecting the top three finishers of the race. The user may override the selection of three runners for a Trifecta Box type of wager by increasing the number of runners selected for a Trifecta Box type of wager. The user may select as many runners as desired to finish as the top three finishers of the face. As a further example, for a Superfecta Box type of wager, the computer 11 randomly selects four runners because the computer is selecting the top four finishers of the race. The user may override the selection of four runners for a Superfecta Box type of wager by increasing the number of runners selected for a Superfecta type of wager. The user may select as many runners as desired to finish as the top four finishers of the race.

In yet another embodiment of the invention, the user may choose to have the random selection of runner(s) influenced by professional handicappers. Selections by professional handicappers may be downloaded to computer 11. The user then is able to select which professional handicapper is to influence the user's selection. The user thereby is able to override the random selection of the runner(s) by choosing which professional handicapper's selection is to influence the user's selection of runner(s). The computer 11 may be programmed to case video segments of the selected professional handicapper to appear on the display 47 of the input wagering terminal 3. The user may also be able to interact with the professional handicapper through the input wagering terminal 3 via electronic mail, or other common modes of communication via network.

In the alternative, the user can optionally override the selection of the real time live race or game by the computer 11 by selecting the type of breed or animal to be selected. For example, the user may be to select races in which thoroughbreds are racing, harnesses or greyhounds.

In one embodiment of the invention, the computer 11 may be programmed to employ runner selection algorithms in the selection of runners. The runner selection algorithms may use handicapping information to identify a set of runners. The algorithm analyzes for each runner the handicapping information including without limitation the runner's statistics, runner's jockey statistics, the track condition of the race, and the times between races for the runner. Further the algorithm analyzes for each runner the odds information for the race.

Users that place wagers within a shorter time frame of a race start are considered to be more successful wagers or “smart money.” In one embodiment of the invention, the computer 11 creates algorithms based on such “smart money” wagers. Such algorithms may be used as handicapping information to identify a set of runners for future races and users' wagers.

In one embodiment of the invention, the computer 11 is programmed to cause marketing and advertising promotion video segments to appear on the display 47 of the input wagering terminal 3. The marketing and advertising promotion video segments may include pre-recorded video advertisements, in- video ticker-tape crawl, video banners, pre-recorded interviews concerning the advertised product or services, and short films concerning the advertised product or services. Such marketing and advertising promotion video segments may be fed into the input wagering terminal 3 via an Internet connection or direct feed. Alternatively, the advertisements and marketing promotions may be integrated via conventional Internet advertising means including banners and pop up windows.

In one embodiment of the invention, the input wagering terminal 3 is also designed to provide conventional slot machine wagering, including for example the games slots, video poker, video blackjack, Caribbean stud, and Texas Hold'em. The input wagering terminal 3 then allows the user to switch between placing wagers on real time live races and games on the one hand and placing wagers on conventional wagering games such as those just listed on the other hand. By providing the user with traditional types of slot machine gambling, the user can avoid any “down time” in gambling that might otherwise cause the user to become bored and walk away from the input wagering terminal 3. The system could be arranged so that the user can switch between placing wagers on live action races and placing wagers on conventional slot machine wagering games by simply depressing a button on the front display wall 31 of the input wagering terminal 3.

In one embodiment of the present invention, the user can increase the wager amount for each pending wager once that pending wager has been created by the computer 11. The user may increase the wager for a pending wager by: by increasing the amount of available credits to be placed on the pending wager; by depositing a coin 39 or other token into the slot or opening; by inputting a credit card or card issued by the facility that may function similarly to a debit card issued by a financial institution into the reader or scanner 45, or; by inputting a cash voucher into the voucher reader 57. The system could be arranged so that the user can increase the wager for a pending wager by simply depressing a button on the front display wall 31 of the input wagering terminal 3.

In one embodiment of the present invention, once the return for the in progress wagers are identified, the return of the user's in progress wagers may be displayed in slot machine format. Preferably, the return of the user's in progress wagers may appear in “reel” format similar to results appearing in a slot machine. The return of the user's in progress wagers may be displayed in slot machine format on the display 47 of the input wagering terminal 3. Preferably, the return of the user's in progress wagers may be displayed on a separate screen on the display 47. The return of the user's in progress wagers may correlate to a pay table wherein the number of credits won by the user correlates to sets of characters. The return of a user's in progress wagers can then be displayed on a pay line. The return of the user's in progress wager may be displayed on the pay line by displaying the set of characters from the pay table that correlate to the return identified for the user's in progress wager. The characters displayed on the pay line above may correlate to the return of the user's in progress wager and more specifically to the number of credits won by the user for such in progress wager. The correlation between the characters displayed in the pay line and the return of the user's in progress wagers can be shown on a pay table.

In one embodiment, using a random number generator, at least one randomly selected wagering base (i.e., a randomly selected real time event, a randomly selected type of wager, and a randomly selected runners, teams or specific players) are randomly selected prior to an input wager placed by the user. The at least one randomly selected wagering base becomes a possible wager from which a user may select to place an input wager to become a pending wager. The random selection of the randomly selected wagering base may be programmed to occur at predetermined intervals.

In one embodiment, the possible wagers for a user would appear in “reel” format wherein such possible wager would appear as a slot machine spinning reel and only revealing one element of the possible wager. The user may then touch the display 47 causing such spinning reel to reveal additional elements of the possible wager. If the user chose to reveal all elements of a possible wager by touching the display 47 a specified number of times, then such possible wager for that would become an in progress wager.

In another embodiment, the possible wagers or elements of a wager appear as floating balloons or floating items on the display 47. The user may then touch the display 47 causing such balloon or floating items to reveal additional elements of the possible wager. If the user chose to reveal all elements of a possible wager by touching the display 47 a specified number of times, then such possible wager for that would become an in progress wager.

In another embodiment, the possible wagers or elements of possible wagers are displayed on the display 47 by illustrating characters climbing ladders. As each character will climb up a different ladder on the display 47, elements of possible wager information are revealed. As each character climbs the ladder, elements of the possible wager are revealed and the number of credits associated with such wager increases. A user may touch the display 47 and touch a specific ladder to select possible wager to become an in progress wager.

In another embodiment, the possible wagers may appear as a rotating wheel revealing elements of a possible wager. A user may touch the display 47 and touch a specific portion of the wheel to select a possible wager to become an in progress wager.

In another embodiment of the invention, in the event the computer 11 selected races that begin within a longer period of time, the computer 11 may be programmed to have a “bonus” game option for the user which allows the user to play alternative games to occupy the user's time. The computer may also be programmed to have an interactive world in which the user may win credits that may be used towards the user's future wagers.

The present invention may further be directed to a method of wagering on automobile racing. The method includes the including the steps of an input wager placed by a user, where at least part of the wagering base is at least two automobile races, specifically automobile races that in real time have yet to start and possess start times that fall within a predetermined period of time from the time in which the input wager was placed by the user; the at least two real time automobile races are randomly selected from any real time automobile races that fall within the predetermined period of time by assigning a random number to each real time automobile race using a random number generator; a type of wager for the randomly selected real time automobile race is then randomly selected using a random number generator; using the randomly selected type of wager, the number of racers are then determined in accordance with the number of racers required for the type of wager; a racer or racers for each randomly selected real time automobile race are randomly selected using the random number generator; the at least two real time automobile races, the randomly selected type of wagers and the randomly selected runners (the “randomly selected wagering base”) are correlated to the input wager and become the user's “pending wager;” once said real time automobile race begins, the user's pending wager becomes the user's “in progress wager;” the outcome of the randomly selected real time automobile race is identified; the outcome of the randomly selected real time automobile race is correlated to the user's in progress wager, and a return for the in progress wager is identified.

The present invention may further be directed to any other type of sporting events, including but not limited to football, baseball, basketball, golf and hockey sporting events.

In one embodiment, the wagering base is made up at least in part by at least one real time sporting event, such as a baseball game. The computer 11 randomly selects the type of wager such as a single sporting event (e.g., a baseball game); multiple selections of performance statistics for individual players of a sporting event (e.g., runs, hits, yardage, goals, or assists of individual players of a sporting event); multiple selections of sporting events within a specific sport (e.g., multiple baseball games); multiple selections of performance statistics for individual players of multiple sporting events (e.g., runs, hits, yardage, goals, or assists of individual players of multiple sporting events).

An example of a type of wager would be the random selection of a single sporting event wherein the computer makes a random single selection of a sporting event that has yet to start.

Another example of a type of wager would be similar to a parlay card form of wagering wherein the computer 11 randomly selects a random number of sporting events to comprise the wagering base such as a number of baseball games that have yet to start. In such example, the computer 11 may randomly select a number of baseball games to comprise the wagering base. Another example of a type of wager is the random selection of a single sporting event and subsequently the random selection of performance statistics of individual players within such game. In such example, the computer 11 randomly selects a baseball game that has yet to start and then randomly selects a performance statistic or multiple performance statistics within such game to form the wagering base. For example, the computer 11 may randomly select a baseball game and then further randomly select a performance statistic of a number of players in such game.

Another example of a type of wager is the random selection of a multiple sporting events and subsequently the random selection of performance statistics of individual players within such games.

Another example of a type of wager is Pick 4 or Pick 5 wherein the computer 11 may randomly select four or five sporting events to comprise the wagering base.

Using the randomly selected type of wager, the number of teams, games, players or player statistics are then determined in accordance with the number of teams, games, players or player statistics required for the type of wager selected. The computer 11 then searches the real time sporting events that are scheduled to begin within a predetermined period of time from the time the user places a discrete object in the input wagering terminal. In one example, the computer 11 may search the real time baseball games that are scheduled to begin within a predetermined period of time from the time the user places a discrete object in the input wagering terminal. The random number generator 13 is programmed to assign a random number to each real time live sporting event that is scheduled to begin within that predetermined period of time. Based on the randomly selected type of wager, the computer 11 then randomly selects the real time live sporting events. Having determined the number of team(s), game(s), player(s) or player statistics required for each randomly selected type of wager, the computer 11 then randomly selects the team(s), game(s), player(s) or player statistic(s) for the randomly selected real time live races or games and randomly selected type of wagers. The at least two real time events, the randomly selected type of wagers and the randomly selected team(s), game(s), player(s) or player statistic(s) (the “randomly selected wagering base”) are correlated to the input wager and become the user's “pending wager;” once said real time event begins, the user's pending wager becomes the user's “in progress wager;” the outcome of the randomly selected real time event is identified; the outcome of the randomly selected real time event is correlated to the user's in progress wager, and a return for the in progress wager is identified.

In another embodiment, the present invention may further be directed to wagering on fantasy type of sporting events, including but not limited to fantasy football, fantasy baseball, fantasy basketball, and fantasy hockey sporting events. In such embodiment, the computer 11 may be programmed to randomly select a user's team by randomly selecting each player or runner to comprise such user's fantasy team. In one embodiment, the user may choose to have the random selection influenced by the selection of a favorite team by the user or by a professional handicapper. In another embodiment, the user may override the random selection by selecting a player or runner. The randomly selected team may then be entered into the pari mutual pool for such types of fantasy teams.

In one embodiment, the first step is to randomly select a type of wager for the real time horse or dog races or jai alai games using a random number generator; the number of runners are then determined in accordance with the number of runners required for the type of wager using a random number generator; the random number generator then randomly selects at least one random number that will be used to identify the runner or player in a real time horse or dog races or jai alai games that has yet to begin; the randomly selected type of wager, the number of runners and the randomly selected numbers become the randomly selected wagering base. Such randomly selected wagering base is entered into the pari-mutuel pool that is established for all of the real time horse or dog races or jai alai games or similar games or races that have yet to begin provided that such type of wager and runner number is available in each race that has yet to begin. Such process allows for multiple wagers to be made simultaneously at different tracks using the same wagering base information

In one embodiment of the present invention, the user is able to select an “autoplay” option in which the user can select the amount of credits to be played and the computer 11 is programmed to randomly select the real time live races or games, types of wagers, and runner(s) for the selected amount of credits. Such autoplay feature may also be included wherein the input wagering terminal 3 is a personal computer or computing device that is linked to the computer 11 and to the random number generator 13 via the Internet. In one embodiment, the user may specify the amount of wager and also set certain parameters such as handicapping options and the speed with which wagers are made. In one embodiment, the Autoplay option may be programmed such that the user may select the win percentage that the user wishes to achieve and the computer 11 is programmed to randomly select the real time live races or games, types of wagers, and runner(s) until such win percentage is achieved.

In one embodiment, the computer 11 may run a simulated wager to provide a tutorial to users as to how the method of pari mutual wagering is achieved. In such simulation, no wager would enter the pari-mutuel pool of wagers but is simply to illustrate the steps of the method. The simulation may be a prerecorded video segment that teaches the user the method and the elements of the game. In another embodiment, the computer 11 may make random selections of the elements of the wagering base in real time to illustrate the aspects of the game. The computer 11 may provide information as to the types of wagers, the events that have yet to begin, the racing tracks, and/or the player(s) or runners. The computer 11 may further provide information as to how the input wagering terminal 3 operates.

The foregoing disclosure has been set forth to illustrate the invention and is not intended to be limiting. Alternative modifications of the disclosed embodiments incorporating the spirit and substance of the invention will occur to persons skilled in the art, and accordingly the invention should be construed to include everything that falls within the scope of the appended claims and equivalents thereof.

What is claimed is:

1. A wagering system comprising: at least one input wagering terminal through which a user places an input wager; a computer or processor with a random number generator that is linked to said input wagering terminal where said computer or processor is networked to race tracks or sporting event venues having real time horse/dog race, jai alai games, automobile races, sporting events or similar games or races and established pari-mutuel betting pools and where when the user places an input wager, said computer or processor is programmed to simultaneously complete the following sequence to form a wagering base that includes at least two wagers for said input wager: a) randomly make at least two selections of at least one real time horse/dog race or jai alai games, automobile races, sporting events or similar games or races that in real time have yet to start and possesses a start time that falls within a predetermined period of time from the time in which the input wager was placed by the user; b) randomly select a type of wager for the at least one real time horse/dog race, jai alai game, automobile race, sporting event or similar game or races that have been randomly selected; c) randomly selecting the runners or players for the at least real time horse/dog race, jai alai game, automobile race, sporting event or similar game or race for said input wager; d) without requiring any input from user, assign said randomly selected real time horse/dog race, jai alai game, automobile race, sporting event or similar game or race, type of wager and runners or players to said input wager to become user's pending wager wherein said pending wager becomes an in progress wager upon the start of said real time horse/dog race, jai alai game, automobile race, sporting event or similar game or race; e) identify outcome of said real time horse/dog race, jai alai game, automobile race, sporting event or similar game or race; and f) identify a return for said input wager.

2. The wagering system according to claim 1 wherein said input wagering terminal is a computing device linked to a host computer or server via the Internet to provide a network to race tracks having real time horse or dog race or jai alai games, or similar games or races and established pari-mutuel betting pools to enter said in progress wager into the pari-mutuel pool that is established for said real time horse or dog race or jai alai game and identify the return for said in progress wager determined by said pari-mutuel pool once the outcome of said real time horse or dog race or jai alai game is identified.

3. The wagering system according to claim 1 wherein said input wagering terminal is a handheld device linked to a host computer or server via the Internet to provide a network to race tracks having real time horse or dog race or jai alai games, or similar games or races and established pari-mutuel betting pools to enter said in progress wager into the pari-mutuel pool that is established for said real time horse or dog race or jai alai game and identify the return for said in progress wager determined by said pari-mutuel pool once the outcome of said real time horse or dog race or jai alai game is identified.

4. The wagering system according to claim 1, wherein the sequence includes the step of providing a network to race tracks having real time horse or dog race or jai alai games, or similar games or races and established pari-mutuel betting pools.

5. The wagering system according to claim 1, wherein the sequence includes the step of entering said in progress wager into the pari-mutuel pool that is established for said real time horse or dog race or jai alai game, or similar games or races.

6. The wagering system according to claim 1, wherein the sequence includes the step of identifying the return for said in progress wager determined by the pari-mutuel pool that is established for said real time horse or dog race or jai alai game, or similar games or races.

7. The wagering system according to claim 1, wherein the input wager may be received from any computing device linked to a host computer or server via the Internet.

8. The wagering system according to claim 1, wherein the input wager may be received from any handheld device linked to a host computer or server via the Internet.

9. The wagering system according to claim 1 wherein the sequence can be executed simultaneously so that a user may be able to place multiple input wagers simultaneously at a single input wagering terminal.

10. The wagering system according to claim 1 including the step of printing a voucher which identifies the results of a winning input wager and has a cash value equivalent to the return on said winning input wager.

11. The wagering system according to claim 1 wherein said input wagering terminal includes a reader scanner to identify information on a card to be used to place an input wager(s).

12. The wagering system according to claim 1 wherein said input wagering terminal includes a display that identifies the user's pending or in progress wagers, including the race track, race, type of wager and runners that have been randomly selected.

13. The wagering system according to claim 12 wherein the display shows multiple lines similar where each slot line corresponds to a possible wager to be selected by the user providing the user the option of selecting from the spinning reels to select the possible wager to become the user's pending wager.

14. The wagering system according to claim 1 including the steps of providing an input wagering terminal and processing a discrete object that is inserted into the input wagering terminal to commence the random number generator.

15. The wagering system according to claim 1, wherein the input wagering terminal has a repositionable element that is accessible to a user and the step of processing a discrete object comprises the step of repositioning the repositionable element after the discrete object is inserted into the input wagering terminal.

16. The wagering system according to claim 1 wherein the input wagering terminal includes a push button that is accessible to a user and the step of processing a discrete object comprises the step of depressing the push button after the discrete object is inserted into the input wagering terminal.

17. The wagering system according to claim 1 wherein the sequence includes the step of assigning an amount of credits to the user corresponding to said money value for each input wager.

16. The wagering system according to claim 1 wherein the sequence includes the step of providing a final return amount for each in progress wager in an amount of credits to the user.

17. The wagering system according to claim 1 wherein the sequence includes the step of providing a money value for the amount of credits corresponding to said final return amount.

18. The wagering system according to claim 1 wherein the amount of an input wager may be increased once a pending wager has been created.

20. The wagering system according to claim 1 wherein the input wagering terminal includes audio and visual signal generators producing at least one of an audio and visual signals to at least one of a) simulate an equestrian event, b) broadcast a live race environment, c) simulate a standard slot machine environment, d) assist placement of input wagers, d) identify the beginning of a wagering period, e) identify the end of a wagering period, and f) simulate a live game environment.

21. The wagering system according to claim 1 wherein the predetermined period of time may be altered or overriden to allow for a shorter or greater predetermined period of time in which real time live races or games can be selected.

22. The wagering system according to claim 1 wherein at least one number is selected that the system would use when randomly selecting the runner(s) such that the at least one number selected must appear in at least one of the runner or other participant numbers selected.

23. The wagering system according to claim 1 wherein at least one “favorite” color is used by the system when randomly selecting the runner(s).

24. The wagering system according to claim 1 wherein at least one runner is selected that the system would use when randomly selecting the runner(s) such that the at least one runner selected must appear in runner(s) or other participant(s) selected.

25. The wagering system according to claim 1 wherein at least one runner is selected that the system would use when randomly selecting the runner(s) such that the at least one runner selected must not appear in runner(s) or other participant(s) selected.

26. The wagering system according to claim 1, wherein a multitude of input wagering terminals are linked together to provide for additional wagers to be made between such input wagering terminals.

27. The wagering system according to claim 1, wherein the at least one real time horse/dog race or jai alai games, automobile races, sporting events or similar games or races randomly selected is an event that is most proximately located to the user.

28. The wagering system according to claim 1 wherein the at least one runner selected is sleeted with input from a handicapper.

29. The wagering system according to claim 1 wherein the computer is programmed to use at least one algorithm to randomly select at least one runner.

30. The wagering system according to claim 29, wherein the at least one algorithm is influenced by at least one handicapper.

31. The wagering system according to claim 29 wherein the at least one algorithm is based on smart money wagers.

32. The wagering system according to claim 1 wherein the display may have multiple slot lines similar to actual slot machine reels where each slot line or “spinning reel” corresponds to a possible wager to be selected by the user.

33. The wagering system according to claim 1 wherein the first step is to randomly select a type of wager for the real time horse or dog races or jai alai games using a random number generator; the number of runners are then determined in accordance with the number of runners required for the type of wager using a random number generator; the random number generator then randomly selects at least one random number that will be used to identify the runner or player in a real time horse or dog races or jai alai games that has yet to begin; the randomly selected type of wager, the number of runners and the randomly selected numbers become the randomly selected wagering base; the randomly selected wagering base is entered into the pari-mutuel pool that is established for all of the real time horse or dog races or jai alai games or similar games or races that have yet to begin provided that such type of wager and runner number is available in each race that has yet to begin.

34. The wagering system according to claim 33 wherein multiple wagers are made simultaneously at different racing tracks.

35. The wagering system according to claim 1, wherein the system provides for “autoplay” where an amount of credits may be selected to be played and the computer is programmed to randomly select the real time live races or games, types of wagers, and runner(s) for the selected amount of credits.

36. The wagering system according to claim 1, wherein the system provides the ability to override the number of runners randomly selected by the computer in a boxed set.

37. The wagering system according to claim 1 wherein at least two users would put an identical input wager and may place wagers against the other at least two users for a specified period of time.

38. The wagering system according to claim 1, the computer runs a simulated wager to provide a tutorial to users as to how the method of pari mutual wagering is achieved.

39. The wagering system according to claim 12, where a plurality of floating characters are displayed on the display wherein at least one of the characters may reveal an element of the wagering base and when at least one character is selected, the remaining wager elements pertaining to that character selection would be revealed to the user.

40. The wagering system according to claim 12, where a set of characters travel from one end of a display screen to the other, such as a character climbing a ladder and as the character moves up the ladder, elements of the wagering base are revealed to the user.

42. The wagering system according to claim 12, where a set of characters travel from one end of a display screen to the other, each character moves towards the opposite end of the display from its starting position at various speeds and when each character reached a predetermined position on the display, the character may reveal a wager element, such as the track, wager type or runner.

43. The wagering system according to claim 12, where a spinning pie may be displayed with a plurality of triangular slices wherein each triangular slice corresponds to a possible wager for the user.

44. The wagering system according to claim 1, wherein the computer is programmed to create an account for each user.

45. The wagering system according to claim 44 wherein the computer is programmed to track each account including the user's wagering history.

46. The wagering system according to claim 1, wherein the wager amount for each pending wager may be increased once that pending wager has been created.

47. The wagering system according to claim 1 wherein the wager would be a parlay wager wherein the user would be required to select the winner of more than one event.

48. The wagering system according to claim 1 wherein the input wagering terminal provide conventional slot machine wagering.

49. The wagering system according to claim 12, wherein the computer is programmed to cause marketing and advertising promotion video segments to appear on the display.

50. A method for wagering on automobile races including the steps of an input wager placed by a user, where at least part of the wagering base is at least two automobile races, specifically automobile races that in real time have yet to start and possess start times that fall within a predetermined period of time from the time in which the input wager was placed by the user;
the at least two real time automobile races are randomly selected from any real time automobile races that fall within the predetermined period of time by assigning a random number to each real time automobile race using a random number generator; a type of wager for the randomly selected real time automobile race is then randomly selected using a random number generator; using the randomly selected type of wager, the number of racers are then determined in accordance with the number of racers required for the type of wager; a racer or racers for each randomly selected real time automobile race are randomly selected using the random number generator; the at least two real time automobile races, the randomly selected type of wagers and the randomly selected runners (the “randomly selected wagering base”) are correlated to the input wager and become the user's “pending wager;” once said real time automobile race begins, the user's pending wager becomes the user's “in progress wager;” the outcome of the randomly selected real time automobile race is identified; the outcome of the randomly selected real time automobile race is correlated to the user's in progress wager, and a return for the in progress wager is identified.

51. A method of wagering on sporting events that includes the steps of an input wager placed by a user, where at least part of the wagering base is at least one real time sporting event, such as baseball, basketball, football or soccer games, specifically sporting events that in real time has yet to start and possess start times that fall within a predetermined period of time from the time in which the input wager was placed by the user; the at least one real time sporting event is randomly selected from any real time events that fall within the predetermined period of time by assigning a random number to each real time sporting event using a random number generator; a type of wager for the randomly selected real time sporting event is then randomly selected using a random number generator; using the randomly selected type of wager, the number of teams or specific players are then determined in accordance with the number of teams or specific players required for the type of wager; a team or specific player for each randomly selected real time event is randomly selected using the random number generator; the at least one real time event, the randomly selected type of wagers and the randomly selected teams or specific player (the “randomly selected wagering base”) are correlated to the input wager and become the user's “pending wager;” once said real time event begins, the user's pending wager becomes the user's
“in progress wager;” the outcome of the randomly selected real time event is identified; the outcome of the randomly selected real time event is correlated to the user's in progress wager, and a return for the in progress wager is identified.

52. A method of wagering according to claim 51 wherein a single sporting event is randomly selected subsequently the random selection of performance statistics of individual players within such game.

53. A method of wagering according to claim 51 for fantasy sporting events which includes the step of a computer programmed to randomly select a user's team by randomly selecting each player or runner to comprise such user's fantasy team.
